(19) United States
(12) Patent Application Publication
(10) Pub. No.: US 2024/0302236 A1
(43) Pub. Date: Sep. 12, 2024

(54) Sensor Package With A Sensor Die

(71) Applicant: TE Connectivity Solutions GmbH, Schaffhausen (CH)

(72) Inventors: David Eric Wagner, Fremont, CA (US); Jose Alfaro Perez, Fremont, CA (US)

(73) Assignee: TE Connectivity Solutions GmbH, Schaffhausen (CH)

(21) Appl. No.: 18/181,836

(22) Filed: Mar. 10, 2023

(51) Int. Cl. G01L 9/00; G01L 9/06

(52) U.S. Cl. CPC G01L 9/0042; G01L 9/06

(57) ABSTRACT

A sensor die includes a carrier wafer having a first cavity and a second cavity and a silicon wafer disposed on the carrier wafer. The silicon wafer has a first membrane aligned with the first cavity and a second membrane aligned with the second cavity. The silicon wafer is monolithically formed in a single piece separate from the carrier wafer and has a wafer thickness that is uniform through the first membrane and the second membrane. The first membrane is deflectable in proportion with an absolute pressure on one of a first wafer side and a second wafer side of the silicon wafer opposite the first wafer side. The second membrane is deflectable in proportion with a differential pressure between the first wafer side and the second wafer side.

### FIELD OF THE INVENTION

The present invention relates to a sensor package and, more particularly, to a sensor die of a sensor package.

### BACKGROUND

A pressure sensor commonly includes a sensor diaphragm and piezoresistors disposed on the sensor diaphragm. An applied force or pressure deflects the sensor diaphragm, which changes the resistance of the piezoresistors on the diaphragm, correspondingly changing a measured output of the pressure sensor that reflects the force or pressure.

Certain applications, such as a mass flow controller, require measurement of both an absolute and a differential pressure. Existing pressure sensors, however, use separate components to measure the absolute and differential pressure, respectively; for example, one sensor diaphragm with piezoresistors measures the absolute pressure and another separate sensor diaphragm with different piezoresistors measures the differential pressure. Using multiple diaphragms to measure these pressures increases the number of components required for the pressure sensor, increasing manufacturing costs. Further, using multiple diaphragms increases the size or footprint of the pressure sensor, which can restrict the use of the pressure sensor in certain applications.

### SUMMARY

A sensor die includes a carrier wafer having a first cavity and a second cavity and a silicon wafer disposed on the carrier wafer. The silicon wafer has a first membrane aligned with the first cavity and a second membrane aligned with the second cavity. The silicon wafer is monolithically formed in a single piece separate from the carrier wafer and has a wafer thickness that is uniform through the first membrane and the second membrane. The first membrane is deflectable in proportion with an absolute pressure on one of a first wafer side and a second wafer side of the silicon wafer opposite the first wafer side. The second membrane is deflectable in proportion with a differential pressure between the first wafer side and the second wafer side.

### BRIEF DESCRIPTION OF THE DRAWINGS

The invention will now be described by way of example with reference to the accompanying Figures, of which:

FIG. 1 is a perspective view of a sensor package according to an embodiment;

FIG. 2 is a sectional perspective view of the sensor package of FIG. 1;

FIG. 3 is a sectional side view of a sensor package according to another embodiment;

FIG. 4 is a sectional side view of a sensor package according to another embodiment;

FIG. 5 is a sectional perspective view of a sensor package according to another embodiment;

FIG. 6 is a sectional perspective view of a sensor package according to another embodiment;

FIG. 7 is a sectional side view of a sensor package according to another embodiment; and

FIG. 8 is a sectional side view of a sensor assembly according to an embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “depth direction” and “width direction”. These descriptors are merely for clarity of the description and for differentiation of the various directions. These directional descriptors do not imply or require any particular orientation of the disclosed elements.

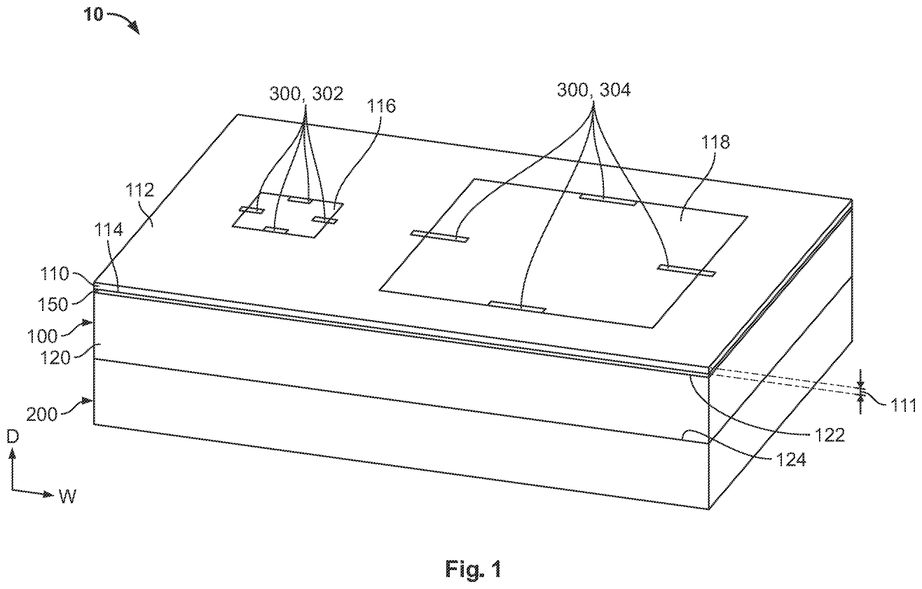

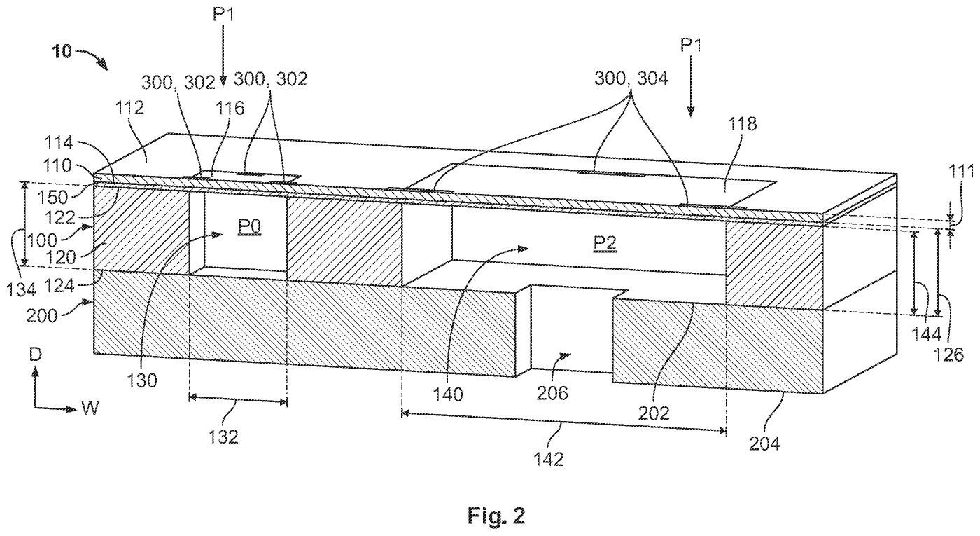

A sensor package 10 according to an embodiment is shown in FIGS. 1 and 2. The sensor package 10 includes a sensor die 100, a constraint 200 on which the sensor die 100 is disposed, and a plurality of piezoresistive elements 300 disposed on the sensor die 100.

The sensor die 100, as shown in FIGS. 1 and 2, includes a silicon wafer 110 and a carrier wafer 120. The silicon wafer 110 has a first wafer side 112 and a second wafer side 114 opposite the first wafer side 112 in a depth direction D. The silicon wafer 110 forms a first membrane 116 in a portion of the silicon wafer 110 and a second membrane 118 in another portion of the silicon wafer 110. The silicon wafer 110 has a wafer thickness 111 that is uniform in a plane perpendicular to the depth direction D, including uniform through the first membrane 116 and the second membrane 118.

The carrier wafer 120, as shown in FIGS. 1 and 2, has a first carrier side 122 and a second carrier side 124 opposite the first carrier side 122 in the depth direction D. In the shown embodiment, the carrier wafer 120 has a carrier thickness 126 in the depth direction D greater than the wafer thickness 111. The silicon wafer 110 and the carrier wafer 120 are each formed of a silicon material and may be formed of a same silicon material.

The carrier wafer 120 has a first cavity 130 and a second cavity 140. The first cavity 130 has a first cavity width 132 in a width direction W perpendicular to the depth direction D and a first cavity depth 134 in the depth direction D. The second cavity 140 has a second cavity width 142 in the width direction W and a second cavity depth 144 in the depth direction D. In the embodiment shown in FIG. 2, the first cavity 130 and the second cavity 140 each extend fully through the carrier wafer 120 in the depth direction D from the second carrier side 124 to the first carrier side 122; the first cavity depth 134 is equal to the second cavity depth 144. In the embodiment shown in FIG. 2, the second cavity width 142 is greater than the first cavity width 132 in the width direction W.

To create the sensor die 100, the silicon wafer 110 is monolithically formed in a single piece with the uniform wafer thickness 111 separate from the carrier wafer 120. The second wafer side 114 of the silicon wafer 110 is then attached to the first carrier side 122 of the carrier wafer 120 with an etch stop 150 between the silicon wafer 110 and the carrier wafer 120 in the depth direction D. In the embodiment of FIGS. 1 and 2, the etch stop 150 is an oxide material layer that attaches the silicon wafer 110 to the carrier wafer 120. The term “wafer” is used for consistency to refer to the silicon wafer 110 and the carrier wafer 120, but these wafers 110, 120 would be cut to create the sensor die 100 as described and shown herein.

In various embodiments, the silicon wafer 110 can be attached to the carrier wafer 120 prior to or after the formation of the first cavity 130 and the second cavity 140 in the carrier wafer 120. In an embodiment in which the carrier wafer 120 is a solid piece of silicon material when the silicon wafer 110 is attached to the carrier wafer 120, the first cavity 130 and the second cavity 140 are both formed into the carrier wafer 120 by a single etching, starting at the second carrier side 124 of the carrier wafer 120. The etching, for example deep reactive-ion etching (DRIE) or wet etching, simultaneously etches the first cavity 130 and the second cavity 140 into the carrier wafer 120 starting at the second carrier side 124. The etching continues until it reaches the etch stop 150; fully forming the first cavity 130 and the second cavity 140 with the cavity widths 132, 142 and cavity depths 134, 144 as described above and preventing the etching from reaching the silicon wafer 110.

In the sensor die 100, as shown in FIG. 2, a portion of the silicon wafer 110 that extends over the first cavity 130 and is aligned with the first cavity 130 in the depth direction D is the first membrane 116 of the silicon wafer 110. A portion of the silicon wafer 110 that extends over the second cavity 140 and is aligned with the second cavity 140 in the depth direction D is the second membrane 118 of the silicon wafer 110. The silicon wafer 110, as described above, has the uniform wafer thickness 111 through the first membrane 116 and the second membrane 118 and is monolithically formed in a single piece with the first membrane 116 and the second membrane 118.

As shown in FIGS. 1 and 2, the constraint 200 has a first surface 202 and a second surface 204 opposite the first surface 202 in the depth direction D. The constraint 200 has a differential constraint port 206 extending through the constraint 200 in the depth direction D from the first surface 202 to the second surface 204. The constraint 200, in various embodiments, can be monolithically formed in a single piece from a glass or a silicon material.

In the sensor package 10 shown in FIGS. 1 and 2, the sensor die 100 is disposed on the constraint 200, with the second carrier side 124 of the carrier wafer 120 attached to the first surface 202 of the constraint 200. In the shown embodiment, the constraint 200 encloses the first cavity 130. The differential constraint port 206, as shown in FIG. 2, is aligned with the second cavity 140 and communicates with the second cavity 140.

The piezoresistive elements 300, as shown in FIGS. 1 and 2, include a first set 302 of piezoresistive elements 300 disposed on the silicon wafer 110 at the first membrane 116 and a second set 304 of piezoresistive elements 300 disposed on the silicon wafer 110 at the second membrane 118. As shown in FIGS. 1 and 2, the first set 302 of piezoresistive elements 300 are positioned on a perimeter of the first membrane 116 and are aligned with a perimeter of the first cavity 130 in the depth direction D, and the second set 304 of piezoresistive elements 300 are positioned on a perimeter of the second membrane 118 and are aligned with a perimeter of the second cavity 140 in the depth direction D.

The piezoresistive elements 300 are an elemental material that is patterned over or embedded into the silicon material of the silicon wafer 110; the piezoresistive elements 300 can be positioned on the first wafer side 112 or within the silicon wafer 110. In an embodiment, the elemental material is a positive dopant, such as p-type boron, but could be any type of material used to create a piezoresistor in a silicon material.

In the shown embodiment, the first set 302 of piezoresistive elements 300 includes four piezoresistive elements distributed around the first membrane 116 and forming a first Wheatstone bridge on the first membrane 116. The second set 304 of piezoresistive elements 300 includes four piezoresistive elements distributed around the second membrane 118 and forming a second Wheatstone bridge on the second membrane 118. In other embodiments, the first set 302 and the second set 304 of piezoresistive elements 300 can include three or less or more than four piezoresistive elements 300.

The sensor package 10 with the sensor die 100 is used to measure various pressures, form a physical element or from a fluid, in the environment in which it is placed. A first pressure P1, shown in FIG. 2, acts on the first wafer side 112 of the silicon wafer 110. The location of the first pressure P1 in FIG. 2 is merely exemplary; the first pressure P1 acts across both the first membrane 116 and the second membrane 118 in the depth direction D. The silicon wafer 110 is flexible and elastically deflectable. The first membrane 116 is deflectable in proportion with a magnitude of the first pressure P1 toward the first cavity 130 in the depth direction D and the second membrane 118 is deflectable, independently from the first membrane 116, in proportion with the magnitude of the first pressure P1 toward the second cavity 140 in the depth direction D.

As shown in FIG. 2, the second cavity 140 has a second pressure P2 that enters the second cavity 140 through the differential constraint port 206 and acts on the second wafer side 114 of the silicon wafer 110 at the second membrane 118. The second pressure P2 acts across the second wafer side 114 of the second membrane 118 in the depth direction D opposite to the first pressure P1. As the second pressure P2 acts counter to the first pressure P1 on the first wafer side 112 of the second membrane 118, the second membrane 118 is deflectable in proportion with a differential pressure between the first pressure P1 and the second pressure P2. A resistance of the second set 304 of piezoresistive elements 300 changes in proportion with the deflection of the second membrane 118, and an output signal transmitted through the second set 304 of piezoresistive elements 300 represents the deflection of the second membrane 118 and the differential pressure between the first pressure P1 and the second pressure P2.

The first membrane 116 is deflectable simultaneously with the second membrane 118 under the first pressure P1. The first cavity 130, sealed or enclosed by the constraint 200, has a vacuum pressure or a known pressure P0; the vacuum or known pressure P0 acts on the second wafer side 114 of the first membrane 116 counter to the first pressure P1 on the first wafer side 112 of the first membrane 116. The first membrane 116 is thereby deflectable into the first cavity 130 in proportion with an absolute measure of the first pressure P1 on the first wafer side 112 of the first membrane 116. The first membrane 116 monolithically formed with the second membrane 118 deflects simultaneously with the second membrane 118 but in proportion to a different measure of pressure than the second membrane 118. A resistance of the first set 302 of piezoresistive elements 300 changes in proportion with the deflection of the first membrane 116, and an output signal transmitted through the first set 302 of piezoresistive elements 300 represents the deflection of the first membrane 116 and the absolute measure of the first pressure P1.

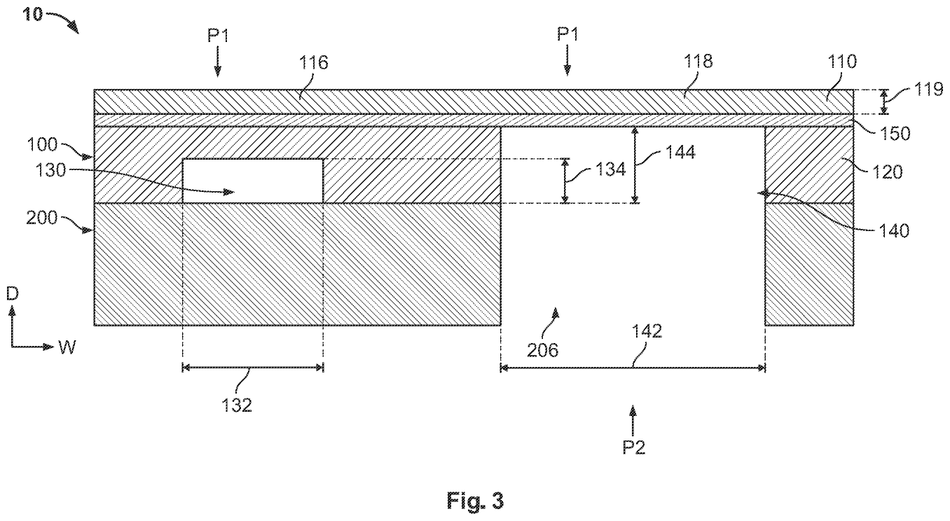

A sensor package 10 according to another embodiment is shown in FIG. 3. Like reference numbers refer to like elements and primarily the differences from the embodiment of the sensor package 10 shown in FIGS. 1 and 2 will be described in detail herein. The piezoresistive elements 300 are omitted in the schematic drawing of FIG. 3 but are present on the first membrane 116 and the second membrane 118 of the sensor package 10 of FIG. 3 in the same manner as described above with respect to the sensor package 10 of FIGS. 1 and 2.

In the sensor package 10 according to the embodiment of FIG. 3, the first cavity 130 and the second cavity 140 of the carrier wafer 120 are sized differently. The second cavity width 142 is still greater than the first cavity width 132 and, in the shown embodiment, the second cavity depth 144 is greater than the first cavity depth 134. In the embodiment shown in FIG. 3, the etching is an aspect ratio dependent etch that etches the second cavity 140 having the second cavity width 142 greater than the first cavity width 132 at a faster rate in the depth direction D than the first cavity 130, reaching the etch stop 150 in the second cavity 140 before the first cavity 130 reaches the etch stop 150.

The etch stop 150, in another embodiment, could be a junction between the silicon wafer 110 and the carrier wafer 120 in lieu of an oxide layer. With such an etch stop 150, the etching could be an electrochemical etch to create the first cavity 130 and second cavity 140 described herein, which may have slanted walls as a result of the electrochemical etch.

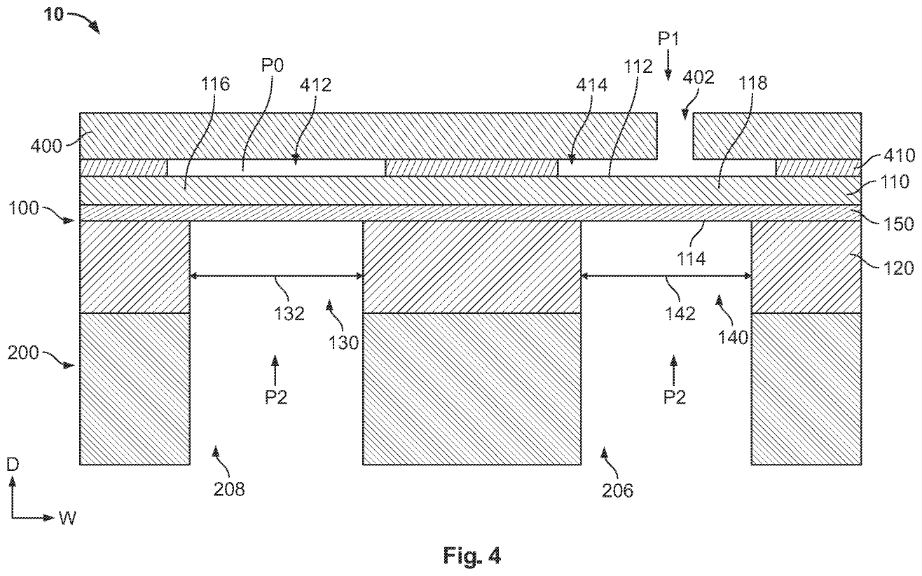

A sensor package 10 according to another embodiment is shown in FIG. 4. Like reference numbers refer to like elements and primarily the differences from the embodiment of the sensor package 10 shown in FIGS. 1 and 2 will be described in detail herein. The piezoresistive elements 300 are omitted in the schematic drawing of FIG. 4 but are present on the first membrane 116 and the second membrane 118 of the sensor package 10 of FIG. 4 in the same manner as described above with respect to the sensor package 10 of FIGS. 1 and 2.

As shown in FIG. 4, the sensor package 10 has a cap layer 400 disposed on a side of the sensor die 100 opposite the constraint 200. The cap layer 400 may be formed of a silicon material. The sensor package 10 has an oxide layer 410 formed of an oxide material and disposed between the cap layer 400 and the sensor die 100 in the depth direction D that attaches the cap layer 400 to the sensor die 100. The oxide layer 410 has a first oxide opening 412 aligned with the first membrane 116 in the depth direction D and has a second oxide opening 414 aligned with the second membrane 118 in the depth direction D. The cap layer 400 encloses the first oxide opening 412 and has a cap port 402 extending through the cap layer 400 and communicating with the second oxide opening 414.

In the embodiment of the sensor package 10 shown in FIG. 4, the first membrane 116 and the second membrane 118 still deflect in proportion with an absolute pressure and a differential pressure, respectively, but are both open to the second pressure P2 through the constraint 200. The constraint 200 of FIG. 4 has an absolute constraint port 208 in addition to the differential constraint port 206 described above. The absolute constraint port 208 communicates with the first cavity 130. As shown in FIG. 4, the first cavity 130 and the second cavity 140 are both etched into the carrier wafer 120 to the etch stop 150 in the depth direction D with the first cavity width 132 equal to the second cavity width 142.

In the sensor package 10 of FIG. 4, the enclosed first oxide opening 412 has the vacuum or known pressure P0. The second pressure P2 reaches the first membrane 116 through the absolute constraint port 208 and the first cavity 130, and the first membrane 116 deflects into the first oxide opening 412 in proportion with an absolute measure of the second pressure P2. The second pressure P2 also reaches the second membrane 118 through the differential constraint port 206 and the second cavity 140, acting on the second wafer side 114 of the second membrane 118. The first pressure P1 enters the second oxide opening 414 through the cap port 402 of the cap layer 400 and acts on the first wafer side 112 of the second membrane 118. The second membrane 118 deflects in proportion with a differential pressure between the first pressure P1 and the second pressure P2.

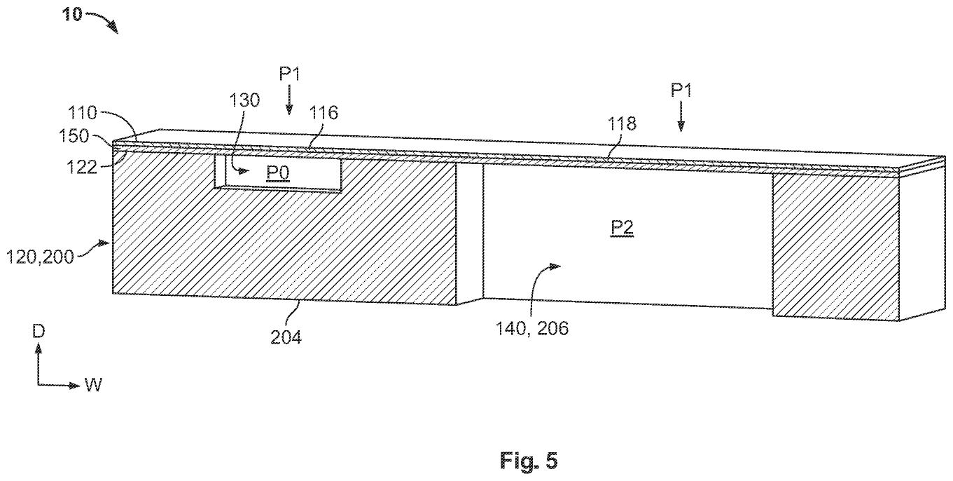

A sensor package 10 according to another embodiment is shown in FIG. 5. Like reference numbers refer to like elements and primarily the differences from the embodiment of the sensor package 10 shown in FIGS. 1 and 2 will be described in detail herein. The piezoresistive elements 300 are omitted in the schematic drawing of FIG. 5 but are present on the first membrane 116 and the second membrane 118 of the sensor package 10 of FIG. 5 in the same manner as described above with respect to the sensor package 10 of FIGS. 1 and 2.

In the sensor package 10 of FIG. 5, the carrier wafer 120 and the constraint 200 are monolithically formed in a single piece from a silicon material, referred to in this embodiment as a base wafer 120, 200. The base wafer 120, 200 is etched from the first carrier side 122 to form the first cavity 130 and is etched through in the depth direction D from the first carrier side 122 to the second surface 204 to form an opening that combines as the second cavity 140 and the differential constraint port 206 described above. The first cavity 130 in this embodiment may be referred to as a buried cavity. In the shown embodiment, the second cavity 140 and the differential constraint port 206 have a same width in the width direction W. The silicon wafer 110 is then bonded to the base wafer 120, 200 to form the first membrane 116 and the second membrane 118. In another embodiment, the opening including the second cavity 140 can be etched after the silicon wafer 110 is bonded to the base wafer 120, 200.

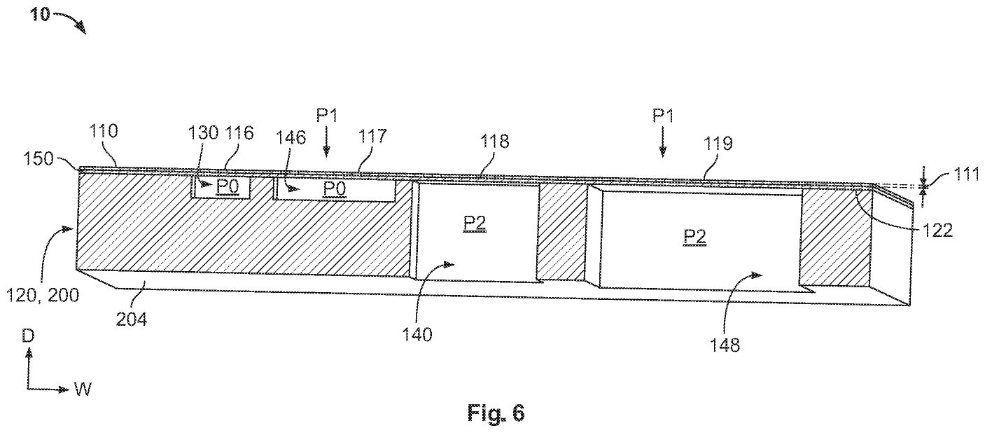

A sensor package 10 according to another embodiment is shown in FIG. 6. Like reference numbers refer to like elements and primarily the differences from the embodiment of the sensor package 10 shown in FIGS. 1 and 2 will be described in detail herein. The piezoresistive elements 300 are omitted in the schematic drawing of FIG. 6 but are present on the first membrane 116 and the second membrane 118 of the sensor package 10 of FIG. 6 in the same manner as described above with respect to the sensor package 10 of FIGS. 1 and 2.

In the embodiment of FIG. 6, the silicon wafer 110 that is monolithically formed in the single piece with the uniform wafer thickness 111 has further membranes in addition to the first membrane 116 and the second membrane 118 described above, and the base wafer 120, 200 has further cavities in addition to the first cavity 130 and the second cavity 140 described above.

As shown in FIG. 6, the base wafer 120, 200 has a third cavity 146 and a fourth cavity 148. The third cavity 146 is formed similarly to the first cavity 130, etched from the first carrier side 122, and has a width in the width direction W that is greater than the first cavity 130. The fourth cavity 148 is formed similarly to the second cavity 140, etched through in the depth direction D from the first carrier side 122 to the second surface 204, and has a width in the width direction W that is greater than the second cavity 140. The third cavity 146 and the fourth cavity 148 are shown with the monolithically formed base wafer 120, 200 in FIG. 6 but could alternatively be formed with the same relative dimensions and arrangement in the carrier wafer 120 according to the embodiment of FIGS. 1 and 2.

A portion of the silicon wafer 110 that extends over the third cavity 146 and is aligned with the third cavity 146 in the depth direction D forms a third membrane 117 of the wafer 110, and a portion of the silicon wafer 100 that extends over the fourth cavity 148 and is aligned with the fourth cavity 148 in the depth direction D forms a fourth membrane 119 of the wafer 110.

The first membrane 116 and the third membrane 117 each deflect in proportion with an absolute measurement of the first pressure P1. Because the third membrane 117 is larger than the first membrane 116 in the width direction W, the third membrane 117 is more sensitive to the first pressure P1 and can be used to measure a lower range of the absolute pressure than the first membrane 116. Likewise, the second membrane 118 and the fourth membrane 119 each deflect in proportion with the differential pressure between the first pressure P1 and the second pressure P2. Because the fourth membrane 119 is larger than the second membrane 118 in the width direction W, the fourth membrane 119 is more sensitive to the differential pressure and can be used to measure a lower range of the differential pressure than the second membrane 118. In an embodiment, an integrated circuit, such as the processing circuit 60 described below, can be used to gather the signals from each of the deflecting membranes 116-119 and determine which measurement range of the absolute pressure and the differential pressure is appropriate for the given application.

The sensor package 10, as shown in FIG. 6, can have a plurality of membranes 116-119 to measure absolute and differential pressure across a plurality of different ranges. The shown embodiment is merely exemplary and, in other embodiments, the sensor package 10 could have further membranes to measure further ranges of the absolute and differential pressures. In another embodiment, a single membrane 116, 118 can be used to measure multiple ranges of the absolute or differential pressure, as disclosed in U.S. Pat. No. 10,871,407.

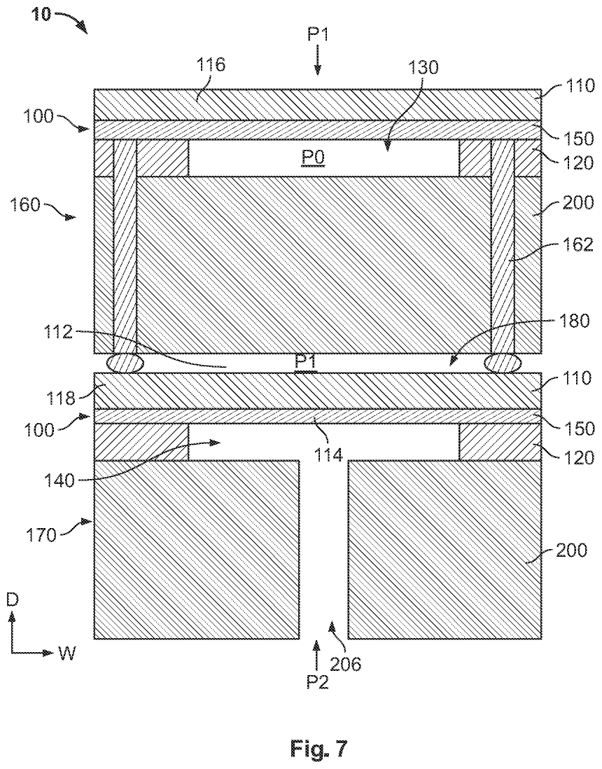

A sensor package 10 according to another embodiment is shown in FIG. 7. Like reference numbers refer to like elements and primarily the differences from the embodiment of the sensor package 10 shown in FIGS. 1 and 2 will be described in detail herein. The piezoresistive elements 300 are omitted in the schematic drawing of FIG. 7 but are present on the first membrane 116 and the second membrane 118 of the sensor package 10 of FIG. 7 in the same manner as described above with respect to the sensor package 10 of FIGS. 1 and 2.

The sensor package 10 of FIG. 7 separates the sensor die 100 and the constraint 200 into a first die portion 160 and a second die portion 170. Each of the first die portion 160 and the second die portion 170 has part of the silicon wafer 110, part of the carrier wafer 120, and part of the constraint 200. In FIG. 7 and in the corresponding description, parts of the silicon wafer 110, carrier wafer 120, and constraint 200 that are in the first die portion 160 and the second die portion 170 will retain the reference numbers used above, but the elements of the first die portion 160 will be referred to below as the “first” element (e.g. first silicon wafer 110) while elements of the second die portion 170 will be referred to as the “second” element (e.g. second silicon wafer 110).

As shown in FIG. 7, the first die portion 160 has the first carrier wafer 120 and the first silicon wafer 110 disposed on the first carrier wafer 120. The first carrier wafer 120 has the first cavity 130 and the first silicon wafer 110 forms the first membrane 116. The first cavity 130 is enclosed by the first constraint 200 to have the vacuum or known pressure P0 in the first cavity 130.

The second die portion 170, as shown in FIG. 7, has the second carrier wafer 120 and the second silicon wafer 110 disposed on the second carrier wafer 120. The second carrier wafer 120 has the second cavity 140 that communicates with the differential constraint port 206 extending through the second constraint 200. The second silicon wafer 110 forms the second membrane 118.

In the sensor package 10 of FIG. 7, the second die portion 170 is disposed under the first die portion 160 in a stacked arrangement; the stacked arrangement decreases a dimension of the sensor package 10 in the width direction W. The first constraint 200 of the first die portion 160 is attached to the second silicon wafer 110 of the second die portion 170 with a gap 180 between the first die portion 160 and the second die portion 170 in the depth direction D. In the shown embodiment, the first die portion 160 is attached to the second die portion 170 by a through-silicon via 162 extending through the first carrier wafer 120 and the first constraint 200.

In the embodiment of FIG. 7, the first membrane 116 of the first silicon wafer 110 is deflectable into the first cavity 130 in proportion with an absolute measurement of the first pressure P1 on the first die portion 160. The first pressure P1 also enters the gap 180 between the die portion 160, 170 around the through-silicon via 162 and acts on the first wafer side 112 of the second silicon wafer 110 at the second membrane 118. The second pressure P2 enters the second cavity 140 through the differential constraint port 206 and acts on the second wafer side 114 of the second membrane 118. The second membrane 118 deflects in proportion with a differential measurement of the first pressure P1 and the second pressure P2.

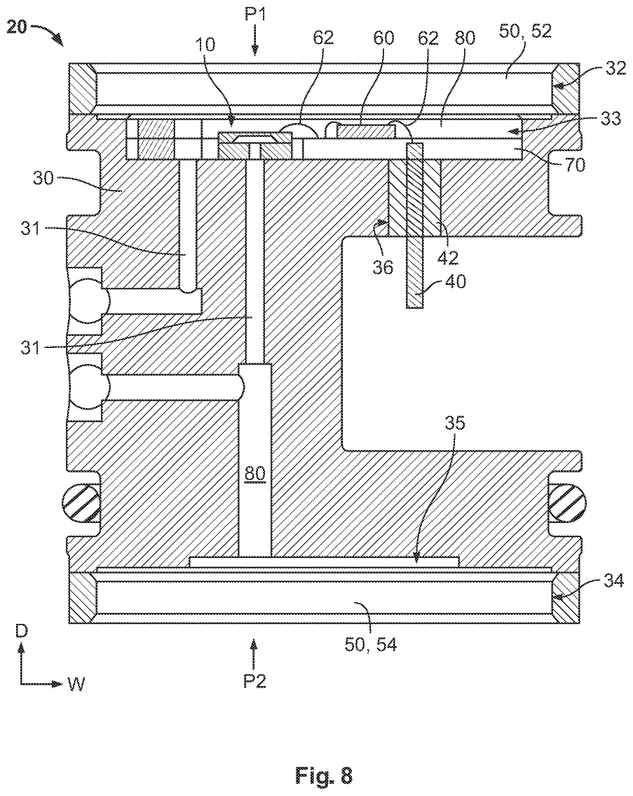

A sensor assembly 20 according to an embodiment is shown in FIG. 8. The sensor assembly 20 includes a housing 30, a plurality of pins 40 disposed in the housing 30, a pair of diaphragms 50 disposed in the housing 30, a sensor package 10 disposed in the housing 30, and a processing circuit 60 disposed in the housing 30. The sensor assembly 20 will be described in an exemplary embodiment in which the sensor package 10 corresponds to the embodiment of the sensor package 10 shown in FIGS. 1 and 2, but the sensor assembly 20 could include the sensor package 10 according to any of the embodiments shown and described above with respect to FIGS. 1-7.

The housing 30, as shown in FIG. 8, has a plurality of oil passageways 31 extending through the housing 30 and connected to a first port 32 and a second port 34 opposite the first port 32 in the depth direction D. The first port 32 and the second port 34 are openings extending into ends of the housing 30. The housing 30 has a first opening 33 between the oil passageways 31 and the first port 32 and a second opening 35 between the oil passageways 31 and the second port 34. A plurality of pin passageways 36, in the shown embodiment, extend from the first opening 33 and through the housing 30 to an area exterior of the housing 30.

As shown in FIG. 8, a plurality of pins 40 extend through the pin passageways 36. The pins 40 each have a first end disposed in the first opening 33 and an opposite second end positioned outside of the housing 30 for an external connection. The pins 40 are each formed of a conductive material and are each sealed by a seal 42, such as a hermetic seal 42, in one of the pin passageways 36. Only one of the pin passageways 36 and one of the pins 40 is shown in the section view of FIG. 8, but the plurality of pins 40 may be arranged in the plurality of pin passageways 36 distributed along a direction perpendicular to the width direction W and the depth direction D.

The diaphragms 50 include a first diaphragm 52 disposed in the first port 32 and a second diaphragm 54 disposed in the second port 34, as shown in FIG. 6. The first diaphragm 52 and the second diaphragm 54 are an elastically flexible material, such as a flexible metal material, that is connected to the housing 30 and encloses the port 32, 34 of the housing 30.

As shown in FIG. 8, the sensor package 10 and the processing circuit 60 are disposed in the first opening 33. The processing circuit 60 is electrically connected to the sensor package 10 and the pins 40 by a plurality of wire bonds 62. The processing circuit 60, for example an Application Specific Integrated Circuit (ASIC), receives the signal output from the sensor package 10 described above that indicates the deflection of the first membrane 116 and the second membrane 118, and the corresponding absolute pressure and differential pressure sensed by the sensor package 10. The processing circuit 60 processes the signals received by the sensor package 10 and outputs the processed signals through the pins 40.

In the embodiment shown in FIG. 8, the processing circuit 60 is positioned in the first opening 33 on a substrate 70. In other embodiments, the processing circuit 60 may be positioned in the first opening 33 directly on the housing 30.

As shown in FIG. 8, the first opening 33 and the second opening 35 are filled with an oil 80 through the oil passageways 31, which can then be sealed. When an external pressure P1, P2 acts on the diaphragm 52, 54, the diaphragm 52, 54 deflects and presses the oil 80 in the oil passageways 31, the first opening 33, and the second opening 35. The oil 80 then acts on the sensor package 10 with the corresponding first pressure P1 and second pressure P2 as described above, and the sensor package 10 outputs the absolute pressure and the differential pressure.

The use of the sensor package 10 that has the first membrane 116 deflecting in proportion with the absolute pressure and the second membrane 118 deflecting in proportion with the differential pressure monolithically formed in the same silicon wafer 110 with a uniform wafer thickness 111 improves manufacturability of the sensor die 100 through the use of fewer components while decreasing the overall size or footprint of the sensor package 10. In the sensor assembly 20, the decreased size of the sensor package 10 permits the positioning of both the sensor package 10 and the processing circuit 60 in the first opening 33 of the housing 30, which further improves manufacturability and the size of the sensor assembly 20, while simplifying the connections between the sensor package 10 and the processing circuit 60.

What is claimed is:

1. A sensor die, comprising:
a carrier wafer having a first cavity and a second cavity; and
a silicon wafer disposed on the carrier wafer, the silicon wafer has a first membrane aligned with the first cavity and a second membrane aligned with the second cavity, the silicon wafer is monolithically formed in a single piece separate from the carrier wafer and has a wafer thickness that is uniform through the first membrane and the second membrane, the first membrane is deflectable in proportion with an absolute pressure on one of a first wafer side and a second wafer side of the silicon wafer opposite the first wafer side, the second membrane is deflectable in proportion with a differential pressure between the first wafer side and the second wafer side.

2. The sensor die of claim 1, further comprising an etch stop between the silicon wafer and the carrier wafer.

3. The sensor die of claim 2, wherein the etch stop is formed of an oxide material layer.

4. The sensor die of claim 1, wherein the first cavity has a first cavity width and the second cavity has a second cavity width greater than the first cavity width.

5. The sensor die of claim 4, wherein the first cavity has a first cavity depth in a depth direction perpendicular to the first cavity width and the second cavity has a second cavity depth in the depth direction perpendicular to the second cavity width, the second cavity depth is equal to the first cavity depth.

6. The sensor die of claim 4, wherein the first cavity has a first cavity depth in a depth direction perpendicular to the first cavity width and the second cavity has a second cavity depth in the depth direction perpendicular to the second cavity width, the second cavity depth is greater than the first cavity depth.

7. The sensor die of claim 1, wherein the first cavity has a first cavity width and the second cavity has a second cavity width equal to the first cavity width.

8. The sensor die of claim 1, wherein the carrier wafer has a third cavity and the silicon wafer has a third membrane aligned with the third cavity, the third membrane is deflectable in proportion with a different range of the absolute pressure than the first membrane.

9. The sensor die of claim 1, wherein the carrier wafer has a fourth cavity and the silicon wafer has a fourth membrane aligned with the fourth cavity, the fourth membrane is deflectable in proportion with a different range of the differential pressure than the second membrane.

10. A sensor die, comprising:
a first die portion having a first carrier wafer and a first silicon wafer disposed on the first carrier wafer, the first carrier wafer has a first cavity, the first silicon wafer is deflectable into the first cavity in proportion with an absolute measurement of a first pressure on the first die portion; and
a second die portion disposed under the first die portion, the second die portion having a second carrier wafer and a second silicon wafer disposed on the second carrier wafer, the second carrier wafer has a second cavity, the second silicon wafer is deflectable in proportion with a differential measurement of the first pressure on the second silicon wafer and a second pressure in the second cavity.

11. The sensor die of claim 10, wherein the first die portion has a first constraint on which the first carrier wafer is disposed, the first constraint is attached to the second silicon wafer with a gap between the first die portion and the second die portion in a depth direction in which the first die portion is stacked on the second die portion.

12. The sensor die of claim 11, wherein the first die portion is attached to the second die portion by a through-silicon via extending through the first carrier wafer and the first constraint.

13. A sensor package, comprising:
a constraint; and
a sensor die disposed on the constraint, the sensor die including a carrier wafer and a silicon wafer disposed on the carrier wafer, the carrier wafer has a first cavity and a second cavity, the silicon wafer has a first membrane aligned with the first cavity and a second membrane aligned with the second cavity, the silicon wafer is monolithically formed in a single piece separate from the carrier wafer and has a wafer thickness that is uniform through the first membrane and the second membrane, the first membrane is deflectable in proportion with an absolute pressure on one of a first wafer side and a second wafer side of the silicon wafer opposite the first wafer side, the second membrane is deflectable in proportion with a differential pressure between the first wafer side and the second wafer side.

14. The sensor package of claim 13, wherein the constraint has a differential constraint port extending through the constraint and communicating with the second cavity.

15. The sensor package of claim 13, wherein the first cavity is enclosed by the constraint and the first cavity has a vacuum pressure.

16. The sensor package of claim 13, further comprising a cap layer disposed on a side of the sensor die opposite the constraint.

17. The sensor package of claim 16, further comprising an oxide layer disposed between the sensor die and the cap layer, the oxide layer has a first oxide opening aligned with the first membrane and a second oxide opening aligned with the second membrane.

18. The sensor package of claim 17, wherein the cap layer encloses the first oxide opening and has a cap port communicating with the second oxide opening.

19. The sensor package of claim 18, wherein the constraint has an absolute constraint port extending through the constraint and communicating with the first cavity.

20. The sensor package of claim 13, further comprising a plurality of piezoresistive elements including a first set forming a first Wheatstone bridge positioned on the first membrane, and a second set forming a second Wheatstone bridge positioned on the second membrane.

21. The sensor package of claim 13, wherein the constraint and the carrier wafer are monolithically formed in a single piece.

22. A sensor assembly, comprising:
a housing having an opening; and
a sensor package disposed in the opening, the sensor package including a sensor die having a carrier wafer and a silicon wafer disposed on the carrier wafer, the carrier wafer having a first cavity and a second cavity, the silicon wafer has a first membrane aligned with the first cavity and a second membrane aligned with the second cavity, the silicon wafer is monolithically formed in a single piece separate from the carrier wafer and has a wafer thickness that is uniform through the first membrane and the second membrane, the first membrane is deflectable in proportion with an absolute pressure on one of a first wafer side and a second wafer side of the silicon wafer opposite the first wafer side, the second membrane is deflectable in proportion with a differential pressure between the first wafer side and the second wafer side.

23. The sensor assembly of claim 22, further comprising a processing circuit disposed in the opening and electrically connected to the sensor die.

24. The sensor assembly of claim 23, wherein the opening is filled with an oil.

25. The sensor assembly of claim 24, further comprising a pin extending through the housing and electrically connected to the sensor die and the processing circuit.

26. The sensor assembly of claim 25, wherein the pin extends through a pin passageway of the housing, the pin passageway is sealed around the pin by a hermetic seal.

27. The sensor assembly of claim 24, further comprising a diaphragm connected to the housing, the diaphragm transmitting an external pressure to the oil in the opening.
